(19) United States
(12) Patent Application Publication
(10) Pub. No.: US 2009/0289893 A1
(43) Pub. Date: Nov. 26, 2009

(54) Finger appliance for data entry in electronic devices

(75) Inventors: Jason Drangel, Rye Brook, NY (US); Sergio Gedanke, Brooklyn, NY (US)

Correspondence Address: EPSTEIN DRANGEL BAZERMAN & JAMES, LLP, 60 EAST 42ND STREET, SUITE 820, NEW YORK, NY, 10165, US

(73) Assignee: AWETHUMB, INC.

(21) Appl. No.: 12/154,234

(22) Filed: May 21, 2008

(51) Int. Cl. G09G 5/00

(52) U.S. Cl. 345/156

(57) ABSTRACT

The appliance is adapted to be mounted on a finger having a finger tip and a finger pad. It includes a finger engaging portion having first and second side members including oppositely oriented, spaced arcuate members and a force application member extending between the first and second side members of the finger engaging portion and abutting the finger tip. The force application member has a blunt surface adapted to contact a key of an electronic device. The blunt surface may have one or more ribs to provide a high friction surface. The appliance defines an opening aligned with the finger pad, so as not to obstruct the finger pad when mounted on the finger.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to a finger appliance and more particularly, a finger appliance for use with small keyboards, roll balls, track balls and touch sensitive screens such as those used on “personal digital assistant” (“PDA”) devices, smart phones, cell phones, electronic notebooks, pagers, portable games as well as other computer and electronic equipment (hereinafter referred to as “electronic devices”), that is useful for entering data and commands, and for accessing information, on such electronic devices.

2. Description of Prior Art Including Information Disclosed Under 37 CFR 1.97 and 1.98

Electronic devices for storing and handling information have come into widespread use in recent years. The electronic devices, in the form of cell phones, smart phones, PDAs, pagers and electronic notebooks, allow individuals to be automated secretaries when away from the home or office. The devices have become even more popular recently with a significant increase in the use of e-mail and text messaging, both for business and in social situations. For many, e-mail and text messaging have replaced the use of telephones and formal written communications. Also, users can now access the Internet through web browsers on the devices due to widespread wireless internet connections.

The electronic devices are most often cell phones that also have data processing capabilities with a microprocessor, a display screen and/or keyboards or keypads. Examples of common electronic devices include the Palm, Blackberry, IPaq, and IPhone. Similar devices of continuously changing design are available on the market by cell phone makers, hardware manufacturers, and phone carriers. Business and social applications for these devices are growing on a daily basis.

At first, such devices primarily received control commands into the display screen on devices such as the Palm and IPaq. Users entered commands and data into the device by touching a portion of the display screen, most often using a pointed instrument such as a stylus. A stylus is a device that looks and functions like a pen without the ink. Most often, users inputted text with the stylus using handwriting recognition software. However, the use of handwriting recognition software never really caught on due to its inaccuracy in interpreting different handwriting.

More recently, with the onset of e-mail and text messaging, the devices include full or modified keyboards to increase efficiency of the user to type data into the device. However, users want smaller and more portable electronic devices. As the devices become smaller and more compact, it follows that the keyboards are also smaller. As a result, each of the individual keys on the keyboard has become quite small and the space between the keys has decreased. The keyboards can take several forms, most often a full QWERTY keyboard with a single letter on each key or a compact QWERTY keyboard with multiple letters on one key, or a telephone numeric keypad that contain multiple letters on each key.

With smaller keyboards, users have grown accustomed to typing with only one or two fingers or thumbs instead of multiple fingers as often used on a standard PC keyboard. The developer of the Blackberry originally designed its keyboard specifically for thumb use, placing the keys on an angle, and with raised keys. Over time, the Blackberry keyboard has returned to its original horizontal structure due to the size of the overall device.

Since users are not accustomed to typing with their thumbs, they often make more mistakes than on a standard PC keyboard. Thumb typing typically requires a user to type while looking at the keyboard. Accordingly, the user must type and then review the text on the screen—as opposed to review while typing. All this is very frustrating to the user, particularly since it is very time consuming to review and revise text using the smaller keyboards.

If a user has big fingers or thumbs, long finger nails, or difficulty seeing small objects, accurate typing can become quite difficult under there circumstances. A user is prone to hit the wrong key or even multiple keys, resulting in incorrect text entries. This slows down the typing process and can be quite frustrating. Successfully typing accurate text is dependent upon having room on the keys and between the keys so that the fingers and thumbs only hit the correct keys. Since in most cases this is not possible due to the size of the devices, there is a need for a product to facilitate increased data entry speed and at the same time promote greater accuracy.

Also, since users are not accustomed to typing with their thumbs, many users have complained of the pain in doing so. Thumb typers have developed what has become commonly known as “Blackberry Thumb.” The thumb works differently from the other fingers. It is designed to oppose the other fingers to facilitate grasping objects. The joint at the bottom of the thumb allows the thumb to flex and rotate. Thus, when people are tapping away at their electronic devices, the thumb is moving in different directions. The typing movement for thumbs can cause problems compared with the other fingers, which only move up and down. Many users have complained of numbness and pain in the thumbs and joints of the hand from the repetitive stress of using devices with small keyboards. Same has even reportedly caused or aggravated arthritis. Accordingly, there is a need for a product to relieve stress on the thumbs, joints and fingers while typing.

The closest devices that appear in the prior art are finger and thumb stylus. The stylus has a somewhat blunted point or tip, in most cases made of hard plastic. The point or tip must have a pen point shape and gliding texture in order to move smoothly along a screen surface and in order to write letters like a writing utensil would. However, an appliance suitable for use with keyboards on data entry devices of the type noted above requires a tip that provides complete access to the keys from all angles. Also, it needs to be formed of material that grips, not slides, in order to grab the keys, roll ball, track ball, etc. Finally, for the most part, a stylus device is attached to the thumb or index finger with a wrap-around strap, ring, or other material that covers the sensitive finger pad portion of the finger or thumb, thereby preventing the user from using the sense of touch to accurately align the finger with the keys.

The only other relevant prior art designs are for standard finger cots used for sorting documents or thimbles for sewing. None of those designs have the structure of the invention or provide a similar function.

For purposes of this disclosure, the word “finger” is used to include all digits of the hand, although the appliance of the present invention is particularly useful when mounted on the thumb or index finger. Thus, “finger” should be read to include the thumb.

It is, therefore, a prime object of the present invention to provide a finger appliance for use with electronic devices.

It is another object of the present invention to provide a finger appliance for use with electronic devices with small data entry means that facilitates the entry of data and commands, and access to information, with increased speed and improved accuracy.

It is another object of the present invention to provide a finger appliance for use on a finger for contacting the keyboard, keys, touch screen, trackballs, or roll balls of an electronic device to affect commands and to enter data.

It is, another object of the present invention to provide a finger appliance that can operate keyboard, keys, touch screen, trackballs, or roll balls of an electronic device and remains securely and comfortably mounted on the finger.

It is another object of the present invention to provide a finger appliance that is adjustable to accommodate fingers and finger nails of various sizes and shapes.

It is another object of the present invention to provide a finger appliance for use with electronic devices that reduces stress caused by entering data or commands using small and closely arranged keys made of hard plastic.

It is another object of the present invention to provide a finger appliance for use with electronic devices which utilizes a blunt surface as a means of transferring force from the finger to actuate the electronic device.

It is another object of the present invention to provide a finger appliance for use with electronic devices which utilizes a rubber or rubber-like surface as a means of transferring force from the finger to actuate the data entry device.

It is another object of the present invention to provide a finger appliance for use with electronic devices which utilizes a ribbed surface as a means of transferring force from the finger to actuate the data entry device.

It is another object of the present invention to provide a finger appliance for use with electronic devices which includes a blunt force application surface formed of a high friction material to enhance the contact with the keys.

It is another object of the present invention to provide a finger appliance for use with electronic devices which includes a detachable member with a blunt force application surface.

It is another object of the present invention to provide a finger appliance for use with electronic devices that does not interfere with the sensation of touch of the finger as the finger actuates the electronic device.

It is another object of the present invention to provide a finger appliance for use with electronic devices which can be easily mounted on and removed from the finger.

It is another object of the present invention to provide a finger appliance for use with electronic devices that is light in weight.

It is another object of the present invention to provide a finger appliance for use with electronic devices that is simple to use.

It is another object of the present invention to provide a finger appliance for use with electronic devices that is inexpensive to make.

It is another object of the present invention to provide a finger appliance for use with electronic devices that is comfortable to wear.

### BRIEF SUMMARY OF THE INVENTION

In accordance with one aspect of the present invention, an appliance is provided for contacting the data entry input of an electronic device. The appliance is adapted to be mounted on a finger of the user. The finger has a finger tip and a finger pad. The appliance includes: finger engaging means having first and second side members; a force application member extending between the first and second side members, and abutting the finger tip. The force application member has a blunt surface.

The appliance has an opening aligned with the finger pad so as not to obstruct the finger pad.

The force application member is integral with the finger engaging means. It is also integral with the first and second side members.

The force application member is formed of flexible material. The finger engaging means is also formed of flexible material.

The appliance also has a member mounted on the force application member and wherein the blunt surface is formed on that member. The member may be detachably mounted on the force application member

The blunt surface includes a high friction surface. The blunt surface further includes one or more ribs.

The force application member preferably substantially follows the contour of the finger tip.

An accordance with another aspect of the present invention an appliance is provided for contacting the data entry input of an electronic device. The appliance is adapted to be mounted on a finger of the user. The finger has a finger tip and a finger pad. The appliance includes: finger engaging means; a force application member abutting the finger tip; and an opening aligned with the finger pad so as not to obstruct the finger pad.

The force application member and the finger engaging means at least partially define the opening.

In accordance with another aspect of the present invention, an appliance is provided for contacting the data entry input of an electronic device. The appliance is adapted to be mounted on a finger of the user. The finger has a finger tip and a finger pad. The appliance includes: finger engaging means, the finger engaging means having first and second spaced, oppositely oriented arcuate members; and a force application member abutting the finger tip.

The appliance first and second arcuate members include means for at least partially encircling the finger.

The finger engaging means further includes first and second side members connecting the first and second arcuate members to the force application member.

The force application member is integral with the finger engaging means. The force application member is also integral with the first and second side members.

An opening may be provided in one or both of the arcuate members. Preferably, the opening is substantially oval.

### BRIEF DESCRIPTION OF THE SEVERAL VIEWS OF DRAWINGS

To these and to such other objects that may hereinafter appears, the present invention relates to a finger appliance for data entry devices as described in detail in the following specification and recited in the annexed claims, taken together with the accompanying drawings, in which like numerals refer to like parts and in which:

FIG. 1 is an exploded isometric view of a first preferred embodiment of the appliance and a finger, illustrating how the appliance is mounted on the finger;

FIG. 2 is an isometric view of the appliance of FIG. 1, showing the top, exterior of one side and the interior of the other side;

FIG. 3 is a side elevation view of the appliance of FIG. 1;

FIG. 4 is a bottom elevation view of the appliance of FIG. 1;

FIG. 5 is a top elevation view of the appliance of FIG. 1;

FIG. 6 is a side elevation view of the appliance of FIG. 1 mounted on the finger of the user, illustrating how force is applied through the blunt surface of the appliance to a key on a data entry device;

FIG. 7 is a view similar to FIG. 6 but illustrating how the finger pad remains unobstructed by the appliance such that the appliance does not interfere with the sense of touch of the user when mounted on the finger;

FIG. 8 is a view similar to FIG. 1 illustrating a second preferred embodiment of the appliance;

FIG. 9 is an isometric view of the appliance of FIG. 8 showing the member with the blunt surface exploded from the appliance; and

FIG. 10 is a cross-sectional view of the detachably mounted member taken along line 10-10 of FIG. 9.

### DETAILED DESCRIPTION OF THE INVENTION

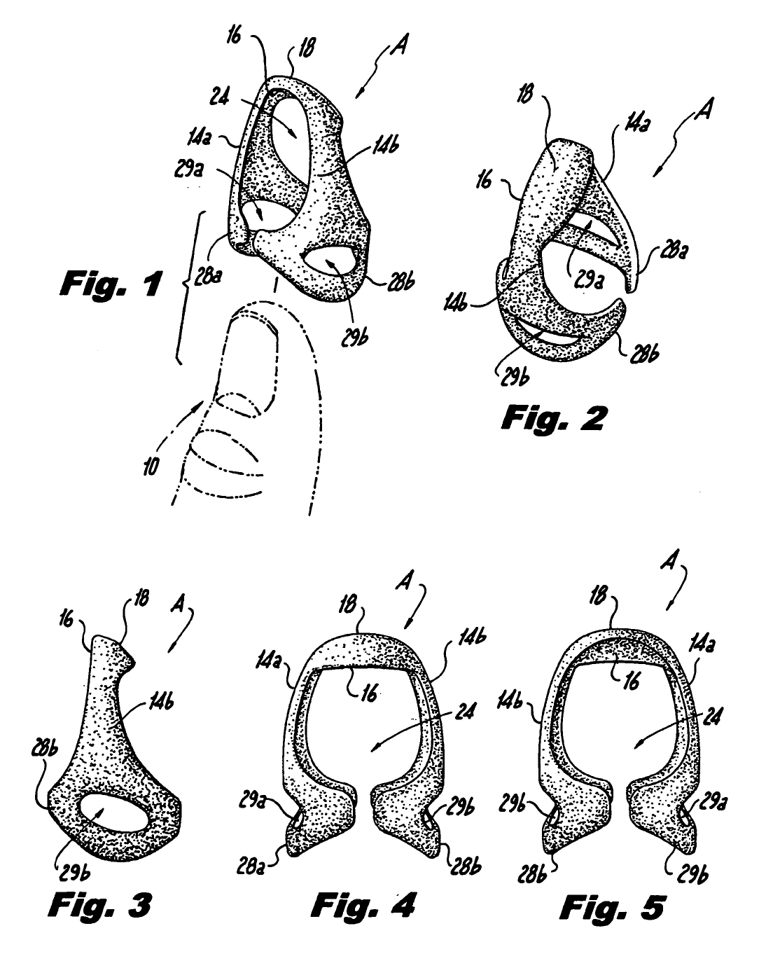

As seen in FIGS. 1 through 7, the first preferred embodiment of the present invention is an appliance, generally designated A, adapted to be mounted on a finger with a fingernail 10 and a finger pad 12. Appliance A includes finger engaging means 14 including first and second side members 14a, 14b and a force application member 16.

Force application member 16 extends between one end of the first side member 14a of the finger engaging means and one end of the second side member 14b of the finger engaging means, across and abutting the tip of the finger, substantially intersecting the plane of the fingernail. Force application member 16 has a blunt surface 18 adapted to contact a key 20 of a data entry device 22.

Finger engaging means 14 also includes finger encircling means formed of first and second oppositely oriented, arcuate members 28a and 28b. The arcuate members 28a and 28b form a part of side members 14a and 14b, respectively. Arcuate members 28a and 28b are spaced from each other a short distance. Since the appliance is formed of a flexible material such as plastic, the space between the arcuate members is variable such that the appliance can fit a wide variety of different size and shape fingers.

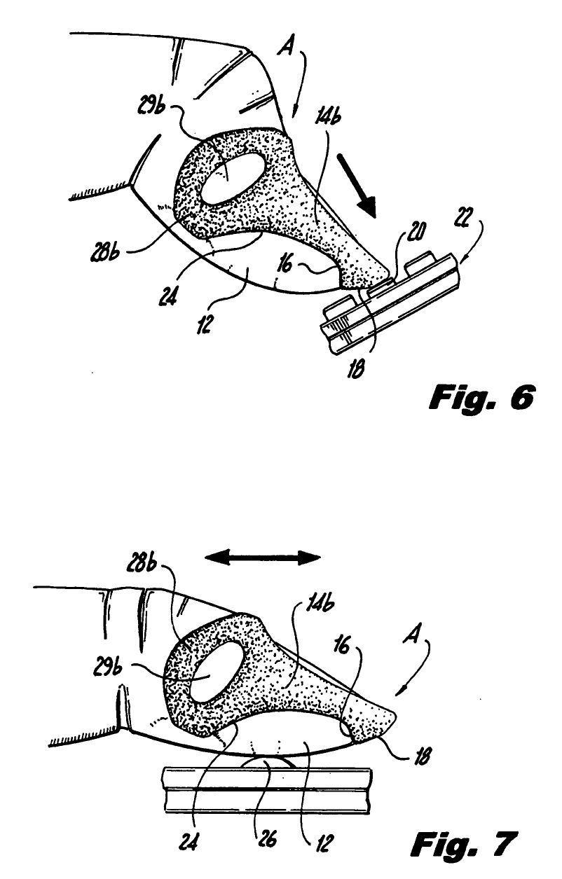

As is best appreciated from FIGS. 6 and 7, force application member 16 and side members 14a, 14b of the finger engaging means (including arcuate members 28a and 28b) at least partially define an opening 24 adapted to align with the finger pad 12. Opening 24 is provided so that the appliance does not to obstruct finger pad 12 and thus allows the user to feel an object, such as a roll ball or track ball 26, when the appliance is mounted on the finger.

The appliance is formed such that the side members must be spread apart, slightly flexing the side members, in order to receive the finger between the arcuate members. Because the side members will tend to move the arcuate members back toward each other as the side members resist the flex, the appliance will grip the finger between the arcuate members to maintain the appliance in the desired position relative to the finger.

Blunt surface 18 of member 16 generally follows the contour of the finger tip below the fingernail. As seen from above or below the appliance, force application member 16 is generally arcuate. It will intersect the plane of the fingernail when the appliance is mounted on the finger.

Arcuate members 28a and 28b may be provided with oval openings 29a and 29b, respectively. Openings 29 provide a means of gripping the appliance to facilitate mounting and removal of the appliance. Further, openings 29 may provide a means of attaching the appliance on a belt clip, string, necklace or the like.

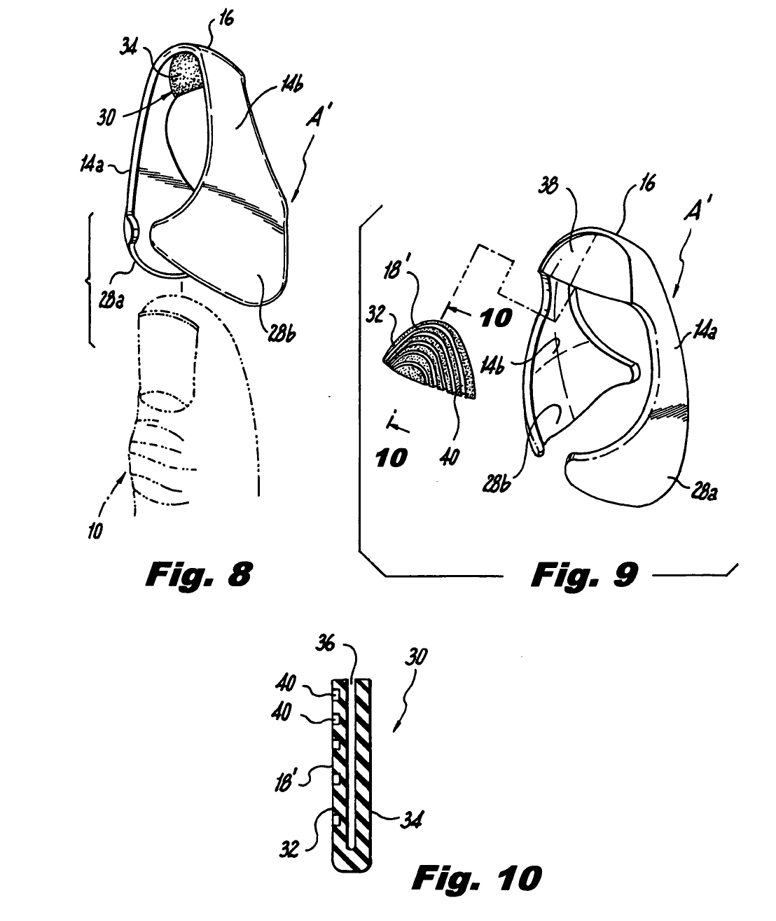

The second preferred embodiment of the appliance of the present invention, generally designated A′, is illustrated in FIGS. 8 through 10. The second preferred embodiment of the present invention is substantially the same as the first preferred embodiment except that: (a) the blunt surface 18′, instead of being formed directly on force application member 16, is formed on a separate member 30 mounted on force application member 16, as is illustrated in FIG. 9; and (b) openings 29 are no longer present in the arcuate members.

As is best seen in FIG. 10, member 30 has a generally “U” shaped cross-section including an external portion 32 and an internal portion 34 which define a recess 36. To mount member 30 on force application member 16, portion 38 of force application member 16, which is generally planar, is received within recess 36 of member 30. Member 30 may be glued or otherwise permanently affixed to portion 38 of force application member 16, if desired, or may be detachably mounted thereto.

In order to increase the frictional characteristic of blunt surface 18′, member 30 may be made of a high friction material, such as rubber or the like, and may include one or more ribs 40 formed in surface 18′. This will create a high friction surface so as to reduce the possibility that the force application member will slide relative to a key 20 and strike a neighboring key when in use.

It will now be appreciated that the present invention relates to an appliance designing to be worn on a finger, particularly but not necessarily the thumb, which is suitable for operating keyboards, roll balls, track balls, and touch sensitive screens on what is known as “personal digital assistants” (“PDA”), smart phones, cell phones, electronic notebooks and electronic games, as well as other computer and data entry equipment, primarily used for entering and accessing data and commands.

The appliance allows the user to type and enter data and commands on such devices faster and with more accuracy. It also eases the pain on the thumbs and fingers by reducing stress in striking the keys on the device keyboards and keypads, which are typically small and made of hard plastic.

The appliance is made of flexible material, and can easily be slipped on and off the user's finger. It is light weight, so that after a short period the user is no longer aware that it is on his or her finger. The appliance is simple to use, inexpensive to make and is comfortable to wear.

The appliance has a flexible, semi-rigid structure that encircles the finger at a point spaced from the tip. It generally conforms to the finger and resiliently grips the finger due to a slight pressure exerted on the finger from each side. The side members flex to retain the appliance in the desired position on the user's finger.

The appliance may be manipulated into comfortable and effective engagement conforming to and cooperating with the finger. The force application member extends across the finger tip and projects outward on a mostly rounded angle but leaves the finger pad substantially unobstructed in order to allow proper contact with the keys, roll ball, track ball, or touch screen without reducing the tactile feeling of the finger pad.

Thus, users can apply pressure to the keys, roll balls, track balls, touch sensitive screens using different points of the finger tip and depending upon which hand the device is used. The appliance is designed so it can be used on any finger on either hand.

The appliance allows the user to obstruct less of the visual field of the keyboard and more dexterously controls contact of the keys, roll balls, track balls and touch sensitive screens when employing the appliance, thereby expediting entering of commands and text to the personal data device.

The appliance is formed such that the sensitive pad of the finger remains unobstructed because in some instances the user will want the tactile feel of the finger to perform functions on the device, including on the keyboards keys, screens, roll balls and track balls. The tactile feel allows the user to know that its actions are completed, sometimes without looking.

The appliance is made of a soft, flexible material such as plastic or rubber to ease the stress on the finger tip and throughout the fingers, joints and hand. The force application member cushions and redirects the impact force resulting from the repetitive contact of the finger tip with the keys, roll balls, and the like, away from the tip of finger, finger nail, and finger joints.

Openings may be present in each side of the appliance to allow the user to use the thumb and forefinger of the opposite hand to more easily mount and remove the appliance. This becomes particularly important when more than one appliance is worn since the appliance is semi-securely mounted on the finger and requires some degree of force to mount or remove. The openings also allow a user to include a clip, string or other attachment means through the opening to store the appliance to a belt clip, zipper, pocketbook, backpack or other structure outside of a pant, shirt or jacket pocket.

The appliance will be provided in several different dimensions or sizes corresponding to a user's finger and thumb size. Force application members of various materials and shapes may be employed for contacting the surface of a particular keyboard, screen, or roll or track balls. In any event, it is important that the force application member be made of a high friction substance that allows it to grip the keys, screens, roll balls and track balls. Also, the member may have a fine, intermediate, or coarse blunt surface texture depending on the purpose of use and feel. Thus the user is afforded an opportunity to select among several sizes and grip textures that are convenient and effective for him or her. The decision may be based upon ease of visual access to keys or the screen, dimensions of the device, and other considerations that affect effectiveness of any particular appliance embodiment.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. An appliance for contacting the data entry input for an electronic device adapted to be mounted on a finger of the user, the finger having a finger tip and a finger pad, said appliance comprising: finger engaging means having first and second side members; a force application member extending between said first and second side members, and abutting the finger tip, said force application member having a blunt surface.

2. The appliance of claim 1 further comprising an opening aligned with the finger pad so as not to obstruct the finger pad.

3. The appliance of claim 1 wherein said force application member is integral with said finger engaging means.

4. The appliance of claim 1 wherein said force application member is integral with said first and second side members.

5. The appliance of claim 1 wherein said force application member comprises flexible material.

6. The appliance of claim 1 wherein said finger engaging means comprises flexible material.

7. The appliance of claim 1 further comprising a member mounted on said force application member and wherein said blunt surface is formed on said member.

8. The appliance of claim 1 wherein said blunt surface further comprises a high friction surface.

9. The appliance of claim 1 wherein said blunt surface comprises a rib.

10. The appliance of claim 1 wherein said force application member is shaped to substantially follow the contour of the finger tip.

11. An appliance for contacting the data input for an electronic device adapted to be mounted on a finger of the user, the finger having a finger tip and a finger pad, said appliance comprising: finger engaging means; a force application member abutting the finger tip, and an opening aligned with the finger pad so as not to obstruct the finger pad.

12. The appliance of claim 11 wherein said force application member and said finger engaging means at least partially define said opening.

13. An appliance for contacting the data input for an electronic device adapted to be mounted on a finger of the user, the finger having a finger tip and a finger pad, said appliance comprising: finger engaging means, said finger engaging means comprising first and second spaced, oppositely oriented arcuate members; and a force application member abutting the finger tip.

14. The appliance of claim 13 wherein said first and second arcuate members comprise means for at least partially encircling the finger.

15. The appliance of claim 13 wherein said finger engaging means further comprises first and second side members.

16. The appliance of claim 13 wherein said force application member is integral with said finger engaging means.

17. The appliance of claim 15 wherein said force application member is integral with said first and second side members.

18. The appliance of claim 13 further comprising an opening in one of said arcuate members.

19. The appliance of claim 13 further comprising an opening in each of said arcuate members.

20. The appliance of claim 18 wherein said opening is substantially oval.
